(19) United States
(12) Patent Application Publication
(10) Pub. No.: US 2019/0044810 A1
(43) Pub. Date: Feb. 7, 2019

(54) CHANNEL WHITELIST AND FLEXIBLE FRAME DESIGN FOR ENHANCED MACHINE-TYPE COMMUNICATIONS SYSTEMS IN UNLICENSED SPECTRUM

(71) Applicant: Intel IP Corporation, Santa Clara, CA (US)

(72) Inventors: Wenting CHANG, Beijing (CN); Huaning NIU, San Jose, CA (US); Salvatore TALARICO, Sunnyvale, CA (US); Anthony LEE, San Diego, CA (US)

(21) Appl. No.: 16/134,124

(22) Filed: Sep. 18, 2018

Related U.S. Application Data
(60) Provisional application No. 62/574,085, filed on Oct. 18, 2017.

(30) Foreign Application Priority Data
Sep. 21, 2017 (CN) PCT/CN2017/102678

(51) Int. Cl. H04L 12/24; H04W 4/70

(52) U.S. Cl. CPC H04L 41/0893; H04L 67/12; H04W 4/70

(57) ABSTRACT

Apparatuses, and computer-readable medium, for supporting the enhanced machine type communications (eMTC) systems operation in the unlicensed band. Some embodiments include different options for channel whitelist configuration to achieve a tradeoff between configuration overhead and the flexibility, and parameters for dwell time of discovery reference signal (DRS), period of DRS, data channels between two adjacent anchor channels, etc.

### REFERENCE TO RELATED APPLICATIONS

This application claims the benefit of PCT Application No. PCT/CN2017/102678 filed Sep. 21, 2017, entitled “CHANNEL WHITELIST AND FLEXIBLE FRAME DESIGN FOR ENHANCED MACHINE-TYPE COMMUNICATIONS SYSTEMS IN UNLICENSED SPECTRUM”, and U.S. Provisional Applications No. 62/574,085 filed Oct. 18, 2017, entitled “CHANNEL WHITELIST AND FLEXIBLE FRAME DESIGN FOR ENHANCED MACHINE-TYPE COMMUNICATIONS SYSTEMS IN UNLICENSED SPECTRUM”, the contents of which are herein incorporated by reference in their entirety.

### FIELD

The present disclosure related to wireless technology, and more specifically to techniques for channel whitelist and flexible frame design for eNHANCED MACHINE-TYPE COMMUNICATIONS systems IN UNLICENSED SPECTRUM.

### BACKGROUND

Internet of Things (IoT) is envisioned as a significantly important technology component, which has huge potential, and may change our daily life entirely by enabling connectivity between tons of devices. IoT has wide applications in various scenarios, including smart cities, smart environment, smart agriculture, and smart health systems.

3GPP has standardized two designs to support IoT services—enhanced Machine Type Communication (eMTC) and NarrowBand IoT (NB-IoT). As eMTC and NB-IoT, User Equipments (UEs) may be deployed in huge numbers, lowering the cost of these UEs is a key enabler for implementation of IoT. Also, low power consumption is desirable to extend the life time of the battery. In addition, there are substantial use cases of devices deployed deep inside buildings, in which coverage enhancement is desired in comparison to the defined LTE cell coverage footprint. In summary, eMTC, and NB-IoT techniques are designed to ensure that the UEs have low cost, low power consumption, and enhanced coverage.

### BRIEF DESCRIPTION OF THE DRAWINGS

Embodiments will be readily understood by the following detailed description in conjunction with the accompanying drawings. To facilitate this description, like reference numerals designate like elements. Embodiments are illustrated by way of examples and not by way of limitation in the figures of the accompanying drawings.

FIG. 1 illustrates an example of EMTC system with some embodiments of the present disclosure.

FIG. 2 illustrates an exemplary electronic apparatus or system in accordance with some embodiments of the present disclosure.

FIG. 3 illustrates an exemplary electronic apparatus or system in accordance with some embodiments of the present disclosure.

FIG. 4 illustrates an example of channel selection in accordance with some embodiments of the present disclosure.

FIG. 5 illustrates an example of channel selection in accordance with some embodiments of the present disclosure.

FIG. 6 illustrates an example of channel selection in accordance with some embodiments of the present disclosure.

FIG. 7 is a flow chart illustrating an exemplary procedure in accordance with some embodiments of the present disclosure.

FIG. 8 illustrates an architecture of a system of a network in accordance with some embodiments of the present disclosure.

FIG. 9 illustrates an architecture of a system of a network in accordance with some embodiments of the present disclosure.

FIG. 10 illustrates example components of a device in accordance with some embodiments of the present disclosure.

FIG. 11 illustrates example interfaces of baseband circuitry in accordance with some embodiments of the present disclosure.

FIG. 12 is an illustration of a control plane protocol stack in accordance with some embodiments of the present disclosure.

FIG. 13 is an illustration of a user plane protocol stack in accordance with some embodiments of the present disclosure.

FIG. 14 illustrates components of a core network in accordance with some embodiments of the present disclosure.

FIG. 15 illustrates a block diagram illustrating components, according to some example embodiments of the present disclosure, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B). Embodiments herein are related to Long Term Evolution (LTE) operation in unlicensed spectrum in MulteFire, specifically the Internet of Things (IoT) operating in unlicensed spectrum.

Internet of Things (IoT)

IoT is envisioned as a significantly important technology component, which has huge potential, and may change our daily life entirely by enabling connectivity between tons of devices. IoT has wide applications in various scenarios, including smart cities, smart environment, smart agriculture, and smart health systems.

3GPP has standardized two designs to support IoT services—enhanced Machine Type Communication (eMTC) and NarrowBand IoT (NB-IoT). As eMTC and NB-IoT UEs will be deployed in huge numbers, lowering the cost of these UEs is a key enabler for implementation of IoT. Also, low power consumption is desirable to extend the life time of the battery. In addition, there are substantial use cases of devices deployed deep inside buildings, which would preferable coverage enhancement in comparison to the defined LTE cell coverage footprint. In summary, eMTC, and NB-IoT techniques are designed to ensure that the UEs have low cost, low power consumption, and enhanced coverage.

LTE Operation in Unlicensed Spectrum

Both Rel-13 eMTC and NB-IoT operate in the licensed spectrum. On the other hand, the scarcity of licensed spectrum in low frequency band results in a deficit in the data rate boost. Thus, there are emerging interests in the operation of LTE systems in the unlicensed spectrum.

Potential LTE operation in the unlicensed spectrum includes, but is not limited to the Carrier Aggregation based on LAA/eLAA systems, LTE operation in the unlicensed spectrum via dual connectivity (DC), and the standalone LTE system in the unlicensed spectrum, where LTE-based technology solely operates in unlicensed spectrum without requiring an “anchor” in licensed spectrum—called MulteFire.

To extend the benefits of LTE IoT designs into unlicensed spectrum, MulteFire 1.1 is expected to specify the design for Unlicensed-IoT (U-IoT). The current disclosure falls in the scope of the U-IoT systems, with focus on the eMTC based U-IoT design. Note that similar approaches may be used to NB-IoT based U-IoT design as well.

Regulations in Unlicensed Spectrum

The unlicensed frequency band of interest in this disclosure is the 2.4 GHz band. For global availability, the design should abide by the regulations in different regions, e.g., the regulations given by FCC in US and the regulations given by ETSI in Europe. Based on these regulations, frequency hopping is more appropriate than other forms of modulations, due to more relaxed power spectrum density (PSD) limitation and co-existence with other unlicensed band technology such as Bluetooth and WiFi. Specifically, frequency hopping has no power spectral density (PSD) limit while other wide band modulations have PSD limit of 10 dBm/MHz in regulations given by ETSI. The low PSD limit would result in limited coverage. Embodiments herein are related to U-IoT with frequency hopping.

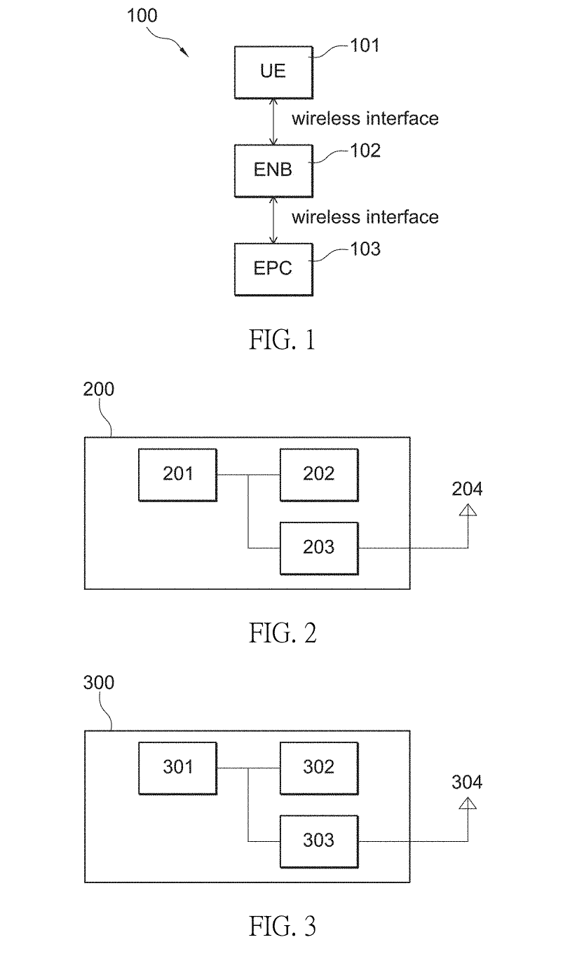

FIG. 1 illustrates an example of EMTC system with some embodiments of the present disclosure. The EMTC system includes a user equipment (UE) 101, an evolved nodeB (eNB) 102, and an evolved packet core (EPC) 103. The UE 101 may communicate with eNB 102 via wireless interface and the eNB 102 may communicate with the EPC 103 via wireless interface.

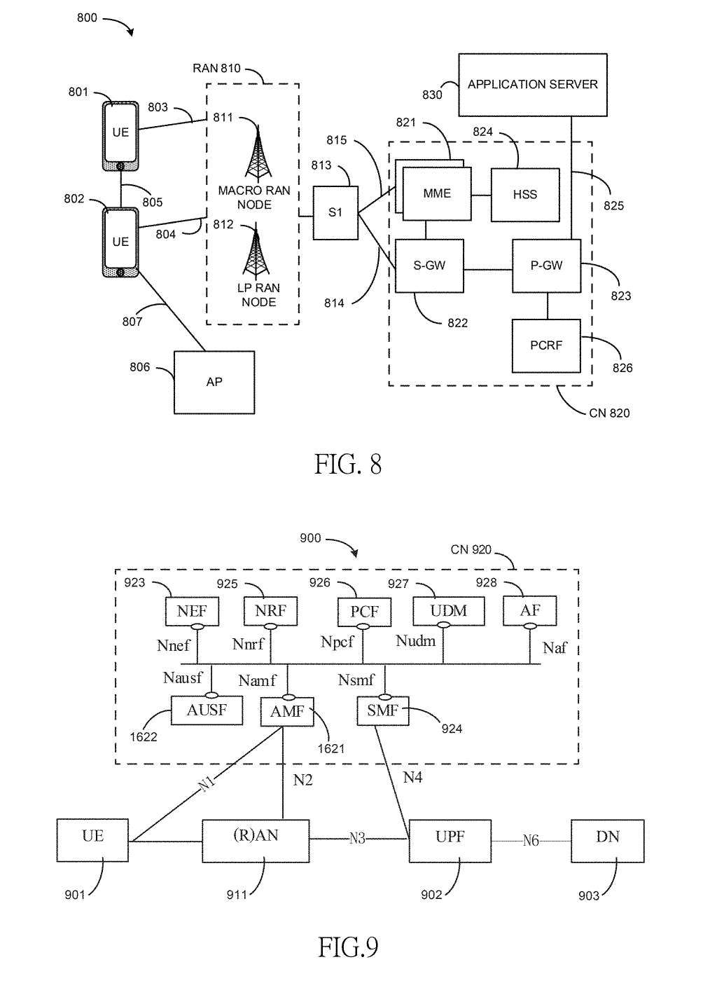

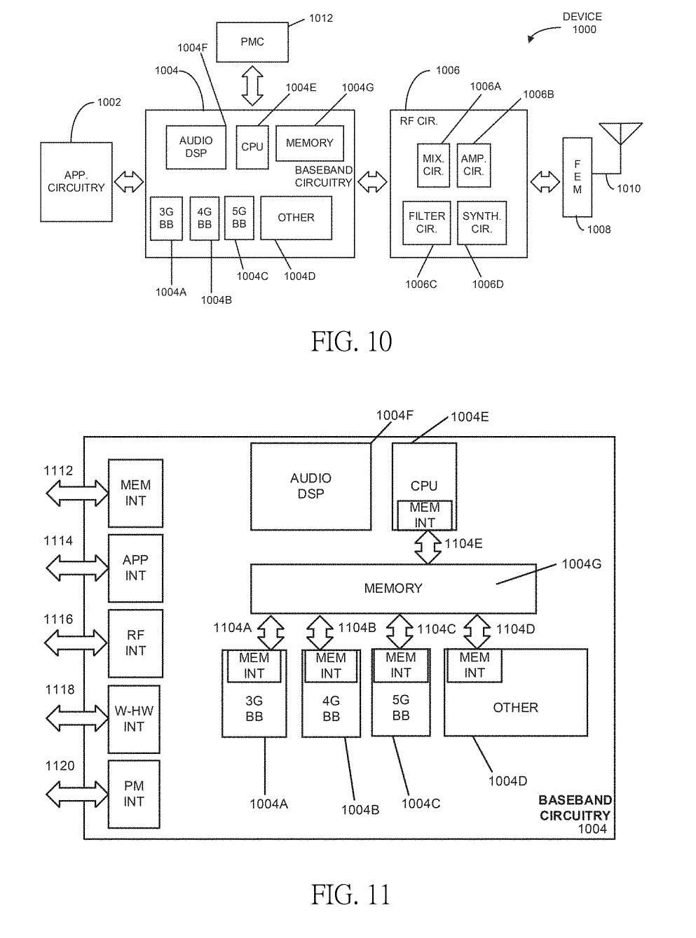

FIG. 2 illustrates an exemplary electronic apparatus or system 200 configured to be employed in an eNB (e.g., the eNB 102 discussed in accordance with FIG. 1 and/or the node 811 or 812 discussed in accordance with FIG. 8, and/or FIG. 11, which will be discussed later). In an embodiment, the electronic system 200 comprises one or more processors 201 (e.g., the one or more processors discussed in accordance with FIG. 10 and/or FIG. 11, which will be discussed later) configured to send a channel whitelist so that UE 101 may transmit or receive in the synced channel with eNB 102 as described above and herein. In an embodiment, the one or more processors 201 may include processing circuitry and an associated memory interface. In an embodiment, the electronic system 200 may further include a memory 202 coupled with the memory interface and communication circuitry 203 containing a transceiver or a transmitter and a receiver coupled to antenna(s) 204. In an embodiment, the electronic system 200 may further include an RF circuitry interface to couple the processing circuitry to RF circuitry.

FIG. 3 illustrates an exemplary electronic apparatus or system 300 configured to be employed in a UE (e.g., the UE 101 discussed in accordance with FIG. 1 or the UE 801 or 802 discussed in accordance with FIG. 8 which will be discussed later). In an embodiment, the electronic system 300 comprises one or more processors 301 (e.g., the one or more processors discussed in accordance with FIG. 10 and/or FIG. 11, which will be discussed later) configured to cause the UE to receive the channel whitelist from eNB 102 as described above and herein. In an embodiment, the one or more processors 301 may include processing circuitry and an associated memory interface. In an embodiment, the electronic system 300 may further include a memory 302 coupled with the memory interface and communication circuitry 303 containing a transceiver or a transmitter and/or a receiver coupled to antenna(s) 304. In an embodiment, the electronic system 300 may further include an RF circuitry interface to couple the processing circuitry to RF circuitry.

In some frequency hopping systems, not all channels will be adopted as the valid channels. The evolved nodeB (eNB) 102 may send a channel whitelist so that user equipment (UE) 101 may transmit or receive in the synced channel with eNB 102. When indicating the channel list, there is a trade-off between the configuration overhead and the flexibility of channel. Embodiments herein provide mechanisms for whitelist configuration enhancements. On the other hand, the anchor channel dwell time and the period of discovery reference signal (DRS) is limited by regulations. Accordingly, in some embodiments the eNB 102 may use a default configuration for whitelist configuration to achieve flexible frame structure.

To support the eMTC system 100 in the unlicensed system, embodiments herein may include the following mechanisms: different options for channel whitelist configuration to achieve the tradeoff between configuration overhead and the flexibility; and the parameter for dwell time of DRS, period of DRS, and the data channels between two adjacent anchor channels, and so on.

Channel List

In embodiments, the channel whitelist may be contained in the system information block (SIB)-bandwidth reduced (BR), or reduced SIB-BR, or master information block (MIB).

In Option 1, a bitmap is utilized where each bit corresponding to a specific channel. “1” means this channel has been chosen, and “0” indicates that this channel will be not chosen. For the case of 83.5 MHz band, a 56-bit bitmap may be used, excluding the 3 anchor channels.

In Option 2, a combination index is utilized when considering all the permutations of the available channels N_{CH} in group of Nd channel. In total, ┌log 2(C_{N}_{_{CH}}^{N}^{_{d}})┘ bits may be required, where N_{CH} is the total channel number, e.g., 56, N_{d} is the number of data channels for hopping, e.g., 15, and C is the operator permutation. In the example, 44 bits may be required. If a larger number of data channel is required, maximum 53 bits may be required

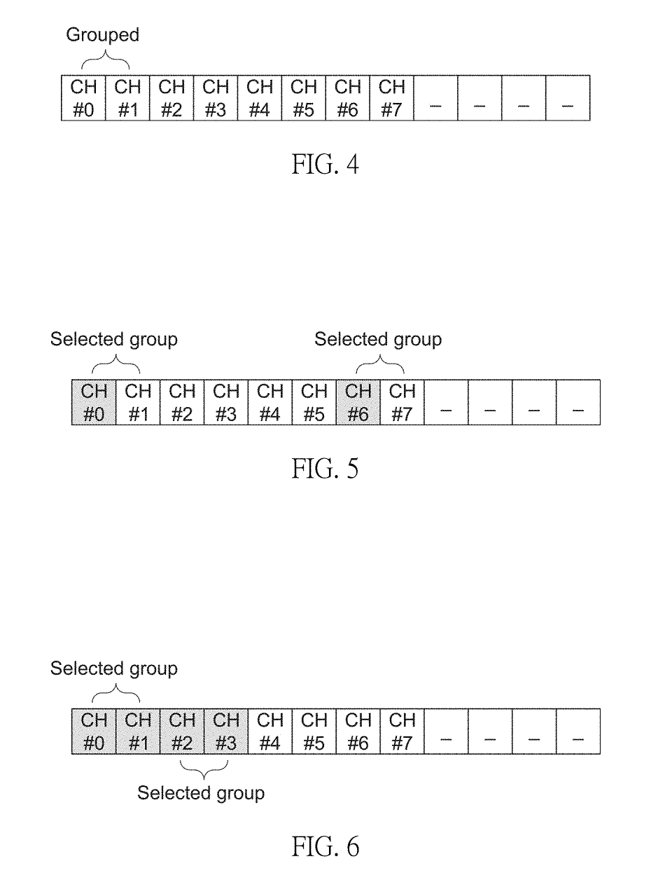

FIGS. 4 and 5 illustrate some examples of channel selection in accordance with some embodiments of the present disclosure. In Option 3, in order to reduce the size for the channel whitelist indication, Ngroup channels may be grouped, e.g., 2, and one of the channels within a group is chose for transmission. Then ┌log 2(C_{┌N}_{_{CH}}_{/N}_{_{group┘}}^{N}^{_{d}})┘ bits may be required to select one of the groups, and ┌log 2(N_{group})┘ bits may be required to select a specific channel, e.g., (26 bits+1 bit) for Ngroup=2. Alternatively, one or more channels within a group may be chosen. For example, if Ngroup=4 and every two channels within a group are chosen, (12 bits+2*2 bit) may be required. For the multiple channel selection within a group, n_{d} channels may be selected, requiring ┌log 2(C_{N}_{_{group}}ⁿ^{_{d}})┘.

FIG. 6 illustrates an example of channel selection in accordance with some embodiments of the present disclosure. In Option 4, in order to reduce the size for channel whitelist indication, Ngroup channels may be grouped, e.g., 2. If a group is chosen, all the channels within that group are also chosen. If the number of data channels exceed the channel Nd number, only part of those channels will be used. Either the large or small channel indexes in the first or last group may be dropped. For instance, 22 bits may be required for Ngroup=2.

In Option 5, in order to reduce the size for the channel whitelist, Ngroup group of channels may be formed, and for each group a permutation of them may be performed over groups of N_{d} channels. Then ┌log₂(N_{group})┘ bits may select the sequence of a specific group, and ┌log 2(C_{N}_{_{d}}^{┌N}^{_{CH}}^{/N}^{_{group}}^{┘})┘ bit may identify a specific sequence within a group. In the example above, 27 bits may be needed for Ngroup.

In embodiments, to further reduce the overhead, the indication for channel group selection in the option 3, option 4, and option 5 may be further reduced.

In some embodiments, the contiguous or equidistant channel groups are selected. For instance, the bit length may be reduced to (4+1) bits for option 3, Ngroup=2, Nd=15, contiguous channel group, and one channel is selected within each group.

In some embodiments, the groups are composed by channels which have a particular structure and two adjacent channels are not distant from each other more than M channels. In this case, the whitelist indicates only a specific sequence, which is much smaller than 26 bits and depends on the value of M. For instance for M=1, only 6 bits may be required. Once M is defined, an approach similar to option 3 or 5 may be used to signal the specific sequence throughout a whitelist.

In embodiments, the channel groups and the channel selection within a group may be indicated by one indicator, to further reduce the overhead by reducing the unused bits.

In embodiments, the data channel number may be associated with the group information.

In one example, there may be 2 channels per group, with a total of 14 data channels, and 21 bits may choose 7 groups out of 28 groups.

In another example, there may be 3 channels per group, with 14 or 15 data channels depending on whether the last group is configured or not, and 14 bits may be needed to choose 5 groups out of 19 groups, while the last group may include two channels.

In another example, there may be 4 channels per group with a total 16 data channels, and 10 bits may choose 4 groups out of 14 groups.

In embodiments where 3 channels per group are configured, 15 bits may be configured to support 15 data channels. In such embodiments, each group contains the three channels, and one channel is contained by the two groups, where the two groups have the same index. The group index 18 may be {CH#52, CH#53, CH#54}, {CH#54, CH#55, CH#56}. Additionally, out of the 15 bits that may be desired, 14 bits may be desired for 5 groups out of 18 groups, and 1 offset bit may be used if group #18 is chosen, 0 for {CH#52, CH#53, CH#54}, and 1 for {CH#54, CH#55, CH#56}.

In some embodiments where 3 channels per group are configured, the 3 channels per group may be configured with 15 bits to support 15 data channels, where each group contains the three channels with a total of 19 groups. Additionally, one channel may be contained by the two groups, where the two groups have the same index. The group index 18 may be {CH#52, CH#53, CH#54}, and the group index 19 may be {CH#54, CH#55, CH#56}. Additionally, 14 bits may be needed.

In embodiments, whether a localized or distributed channel selection is done may be configured by eNB, as well as the group parameters, e.g., M, which are indicated through high layer signaling, e.g., MIB/SIB.

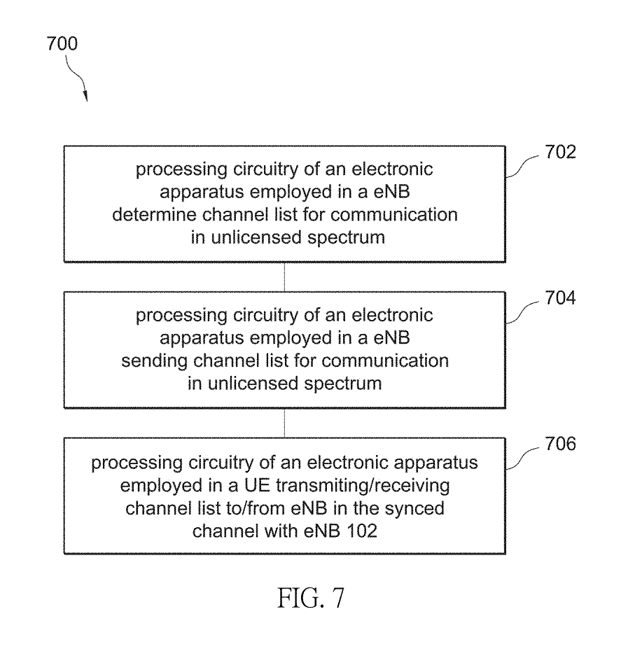

FIG. 7 is a flow chart illustrating an exemplary procedure in accordance with some embodiments of the present disclosure. FIG. 700 is a flow chart illustrating an exemplary procedure 700 that processes a channel list. At operation 702, processing circuitry of an electronic apparatus employed in a eNB determines a channel list for communication in the unlicensed spectrum. In an embodiment, a bitmap is utilized where each bit corresponds to a specific channel. “1” means this channel has been chosen, and “0” indicates that this channel will be not chosen. For the case of 83.5 MHz band, a 56-bit bitmap is preferable, excluding the 3 anchor channels. In another embodiment, a combination index is utilized when considering all the permutations of the available channels N_{CH} in group of Nd channel. In total, ┌log 2(C_{N}_{_{CH}}^{N}^{_{d}})┘ bits may be needed, where N_{CH} is the total channel number, e.g., 56, N_{d} is the number of data channels for hopping, e.g., 15, and C is the operator permutation. In the example, 44 bits may be needed. If a larger number of data channel is preferable, maximum 53 bits may be needed. In another embodiment, in order to reduce the size for the channel whitelist indication, Ngroup channels may be grouped, e.g., 2, and one of the channels within a group is chosen for transmission. Then ┌log 2(C_{┌N}_{_{CH}}_{/N}_{_{group}}_{┘}^{N}^{_{d}})┘ bits may be needed to select a one of the groups, and ┌log 2(N_{group})┘ bits may be needed to select specific channel, e.g., (26 bits+1 bit) for Ngroup=2. Alternatively, one or more channels within a group may be chosen. For example, if Ngroup=4 and every two channels within a group are chosen, (12 bits+2*2 bit) may be needed. For the multiple channel selection within a group, n_{d} channels may be selected, requiring ┌log 2(C_{N}_{_{group}}ⁿ^{_{d}})┘. At operation 704, processing circuitry of an electronic apparatus employed in an eNB may send the channel list for communication in unlicensed spectrum. At operation 706, processing circuitry of an electronic apparatus employed in a UE may transmit/receive the channel list to/from the eNB in the synced channel with eNB 102.

Frame Structure

To meet the regulation, the following two equations may need to be satisfied:

T_{DRS}+N_{d,Return}*T_{d}=40/80/160/320 (Cond. 1)

And/or

N_{d}T_{DRS}=N_{d,Return}*T_{d} (Condi. 2)

where T_{DRS} is the anchor channel dwell time
N_{d,Reture} is the number of data channels between the gap of two adjacent DRS
T_{d} is the dwell time of data channel
N_{d} is the number of data channels

In embodiments, the dwell time of DRS may be changed as:
T_{DRS}=5/8/10/15/20 ms
The period of DRS may be 40/80/160/320

In embodiments, based on the dwell time, and period of DRS, the dwell time of data channel and data channel number, and the number of channels between the gap of two adjacent DRS may be derived based on the below tables.

TABLE 1
if fixing T_{DRS} = 5 ms

| Period | | |
|---|---|---|
| of DRS | N_{d, Return} * T_{d} | N_{d} |
| 40 ms | 35 ms | 7, not satisfy the |
| | | regulation |
| 80 ms | 75 ms | 15 |
| | N_{d, Return} = 1, T_{d} = 75 ms | |
| 160 ms | 155 ms | 31 |
| | N_{d, Return} = 1, T_{d} = 155 ms | |
| 320 ms | 315 ms | 63 |
| | e.g. N_{d, Return} = 3, T_{d} = 105 ms | |
| | N_{d, Return} = 5, T_{d} = 63 ms | |

TABLE 2
if fixing T_{DRS} = 8 ms

| Period | | |
|---|---|---|
| of DRS | N_{d, Return} * T_{d} | N_{d} |
| 40 ms | 32 ms | 5, not satisfy the |
| | | regulation |
| 80 ms | 72 ms | 10, not satisfy the |
| | N_{d, Return} = 1, T_{d} = 72 ms | regulation |
| 160 ms | 152 ms | 19 |
| | N_{d, Return} = 1, T_{d} = 152 ms | |
| | N_{d, Return} = 2, T_{d} = 76 ms | |
| 320 ms | 312 ms | 39 |
| | N_{d, Return} = 1, T_{d} = 312 ms | |
| | N_{d, Return} = 2, T_{d} = 156 ms | |
| | N_{d, Return} = 3, T_{d} = 104 ms | |

TABLE 3
if fixing T_{DRS} = 10 ms

| Period | | |
|---|---|---|
| of DRS | N_{d, Return} * T_{d} | N_{d} |
| 40 ms | 30 ms | 3, not satisfy the |
| | | regulation |
| 80 ms | 70 ms | 7, not satisfy the |
| | N_{d, Return} = 1, T_{d} = 70 ms | regualtion |
| 160 ms | 150 ms | 15 |
| | N_{d, Return} = 1, T_{d} = 150 ms | |
| | N_{d, Return} = 2, T_{d} = 75 ms | |
| | N_{d, Return} = 3, T_{d} = 50 ms | |
| 320 ms | 310 ms | 31 |
| | N_{d, Return} = 1, T_{d} = 310 ms | |
| | N_{d, Return} = 2, T_{d} = 155 ms | |
| | N_{d, Return} = 5, T_{d} = 62 ms | |

TABLE 4
if fixing T_{DRS} = 15 ms

| Period | |
|---|---|
| of DRS | N_{d, Return} * T_{d} |
| 40 ms | 25 ms |
| | N_{d, Return} = 1, T_{d} = 25 ms |
| 80 ms | 65 ms |
| | N_{d, Return} = 1, T_{d} = 65 ms |
| 160 ms | 145 ms |
| | N_{d, Return} = 1, T_{d} = 145 ms |
| | N_{d, Return} = 5, T_{d} = 29 ms |
| 320 ms | 305 ms |
| | N_{d, Return} = 1, T_{d} = 305 ms |
| | N_{d, Return} = 5, T_{d} = 61 ms |

TABLE 5
if fixing T_{DRS} = 20 ms

| Period | |
|---|---|
| of DRS | N_{d, Return} * T_{d} |
| 40 ms | 20 ms |
| | N_{d, Return} = 1, T_{d} = 20 ms |
| 80 ms | 60 ms |
| | N_{d, Return} = 1, T_{d} = 60 ms |
| | N_{d, Return} = 2, T_{d} = 30 ms |
| 160 ms | 140 ms |
| | N_{d, Return} = 1, T_{d} = 140 ms |
| | N_{d, Return} = 2, T_{d} = 70 ms |
| 320 ms | 300 ms |
| | N_{d, Return} = 1, T_{d} = 300 ms |
| | N_{d, Return} = 2, T_{d} = 150 ms |
| | N_{d, Return} = 3, T_{d} = 100 ms |
| | N_{d, Return} = 4, T_{d} = 75 ms |
| | N_{d, Return} = 5, T_{d} = 60 ms |

In embodiments, one or multiple of the aforementioned parameter combinations may be chosen and pre-defined, then eNB will configure it by an index to indicate (DRs N_{d,Reture}, T_{d}, N_{d}, P_{DRS}) in the MIB or SIB, where P_{DRS} is the period of DRS.

In embodiments, the data channel number, N_{d}, may be configured by eNB independently:
A number group may be pre-defined by the eNB.
   The minimum number, e.g., 15 may be contained
   The multiples of the minimum channel may be contained, e.g., {15, 30, 45 60};
   The maximum number of channel is defined, e.g., 56
   The primes number may be adopted for easy random sequence generation, e.g., {17, 19, 23, 29, 31, 37, 41, 43, 47}

An arbitrary channel number is configured by eNB.

FIGS. 8-15

FIG. 8 illustrates an architecture of a system 800 of a network in accordance with some embodiments of the present disclosure. The system 800 is shown to include a user equipment (UE) 801 and a UE 802. The UEs 801 and 802 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 801 and 802 may comprise an Internet of Things (IoT) UE, which may comprise a network access layer designed for low-power IoT applications utilizing short-lived UE connections. An IoT UE may utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 801 and 802 may be configured to connect, e.g., communicatively couple, with a radio access network (RAN) 810—the RAN 810 may be, for example, an Evolved Universal Mobile Telecommunications System (UMTS) Terrestrial Radio Access Network (E-UTRAN), a NextGen RAN (NG RAN), or some other type of RAN. The UEs 801 and 802 utilize connections 803 and 804, respectively, each of which comprises a physical communications interface or layer (discussed in further detail below); in this example, the connections 803 and 804 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 801 and 802 may further directly exchange communication data via a ProSe interface 805. The ProSe interface 805 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 802 is shown to be configured to access an access point (AP) 806 via connection 807. The connection 807 may comprise a local wireless connection, such as a connection consistent with any IEEE 802.11 protocol, wherein the AP 806 would comprise a wireless fidelity (WiFi®) router. In this example, the AP 806 is shown to be connected to the Internet without connecting to the core network of the wireless system (described in further detail below).

The RAN 810 may include one or more access nodes that enable the connections 803 and 804. These access nodes (ANs) may be referred to as base stations (BSs), NodeBs, evolved NodeBs (eNBs), next Generation NodeBs (gNB), RAN nodes, and so forth, and may comprise ground stations (e.g., terrestrial access points) or satellite stations providing coverage within a geographic area (e.g., a cell). The RAN 810 may include one or more RAN nodes for providing macrocells, e.g., macro RAN node 811, and one or more RAN nodes for providing femtocells or picocells (e.g., cells having smaller coverage areas, smaller user capacity, or higher bandwidth compared to macrocells), e.g., low power (LP) RAN node 812.

Any of the RAN nodes 811 and 812 may terminate the air interface protocol and may be the first point of contact for the UEs 801 and 802. In some embodiments, any of the RAN nodes 811 and 812 may fulfill various logical functions for the RAN 810 including, but not limited to, radio network controller (RNC) functions such as radio bearer management, uplink and downlink dynamic radio resource management and data packet scheduling, and mobility management.

In accordance with some embodiments, the UEs 801 and 802 may be configured to communicate using Orthogonal Frequency-Division Multiplexing (OFDM) communication signals with each other or with any of the RAN nodes 811 and 812 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals may comprise a plurality of orthogonal subcarriers.

In some embodiments, a downlink resource grid may be used for downlink transmissions from any of the RAN nodes 811 and 812 to the UEs 801 and 802, while uplink transmissions may utilize similar techniques. The grid may be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently may be allocated. There are several different physical downlink channels that are conveyed using such resource blocks.

The physical downlink shared channel (PDSCH) may carry user data and higher-layer signaling to the UEs 801 and 802. The physical downlink control channel (PDCCH) may carry information about the transport format and resource allocations related to the PDSCH channel, among other things. It may also inform the UEs 801 and 802 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes 811 and 812 based on channel quality information fed back from any of the UEs 801 and 802. The downlink resource assignment information may be sent on the PDCCH used for (e.g., assigned to) each of the UEs 801 and 802.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the downlink control information (DCI) and the channel condition. There may be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 810 is shown to be communicatively coupled to a core network (CN) 820—via an S1 interface 813. In embodiments, the CN 820 may be an evolved packet core (EPC) network, a NextGen Packet Core (NPC) network, or some other type of CN. In this embodiment the S1 interface 813 is split into two parts: the S1-U interface 814, which carries traffic data between the RAN nodes 811 and 812 and the serving gateway (S-GW) 822, and the S1-mobility management entity (MME) interface 815, which is a signaling interface between the RAN nodes 811 and 812 and MMEs 821.

In this embodiment, the CN 820 comprises the MMES 821, the S-GW 822, the Packet Data Network (PDN) Gateway (P-GW) 823, and a home subscriber server (HSS) 824. The MMES 821 may be similar in function to the control plane of legacy Serving General Packet Radio Service (GPRS) Support Nodes (SGSN). The MMES 821 may manage mobility aspects in access such as gateway selection and tracking area list management. The HSS 824 may comprise a database for network users, including subscription-related information to support the network entities' handling of communication sessions. The CN 820 may comprise one or several HSSs 824, depending on the number of mobile subscribers, on the capacity of the equipment, on the organization of the network, etc. For example, the HSS 824 may provide support for routing/roaming, authentication, authorization, naming/addressing resolution, location dependencies, etc.

The S-GW 822 may terminate the S1 interface 813 towards the RAN 810, and routes data packets between the RAN 810 and the CN 820. In addition, the S-GW 822 may be a local mobility anchor point for inter-RAN node handovers and also may provide an anchor for inter-3GPP mobility. Other responsibilities may include lawful intercept, charging, and some policy enforcement.

The P-GW 823 may terminate an SGi interface toward a PDN. The P-GW 823 may route data packets between the EPC network 823 and external networks such as a network including the application server 830 (alternatively referred to as application function (AF)) via an Internet Protocol (IP) interface 825. Generally, the application server 830 may be an element offering applications that use IP bearer resources with the core network (e.g., UMTS Packet Services (PS) domain, LTE PS data services, etc.). In this embodiment, the P-GW 823 is shown to be communicatively coupled to an application server 830 via an IP communications interface 825. The application server 830 may also be configured to support one or more communication services (e.g., Voice-over-Internet Protocol (VoIP) sessions, PTT sessions, group communication sessions, social networking services, etc.) for the UEs 801 and 802 via the CN 820.

The P-GW 823 may further be a node for policy enforcement and charging data collection. Policy and Charging Enforcement Function (PCRF) 826 is the policy and charging control element of the CN 820. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 826 may be communicatively coupled to the application server 830 via the P-GW 823. The application server 830 may signal the PCRF 826 to indicate a new service flow and select the appropriate Quality of Service (QoS) and charging parameters. The PCRF 826 may provision this rule into a Policy and Charging Enforcement Function (PCEF) (not shown) with the appropriate traffic flow template (TFT) and QoS class of identifier (QCI), which commences the QoS and charging as specified by the application server 830.

FIG. 9 illustrates an architecture of a system 900 of a network in accordance with some embodiments of the present disclosure. The system 900 is shown to include a UE 901, which may be the same or similar to UEs 801 and 802 discussed previously; a RAN node 911, which may be the same or similar to RAN nodes 811 and 812 discussed previously; a User Plane Function (UPF) 902; a Data network (DN) 903, which may be, for example, operator services, Internet access or 3rd party services; and a 5G Core Network (5GC or CN) 920.

The CN 920 may include an Authentication Server Function (AUSF) 922; a Core Access and Mobility Management Function (AMF) 921; a Session Management Function (SMF) 924; a Network Exposure Function (NEF) 923; a Policy Control function (PCF) 926; a Network Function (NF) Repository Function (NRF) 925; a Unified Data Management (UDM) 927; and an Application Function (AF) 928. The CN 920 may also include other elements that are not shown, such as a Structured Data Storage network function (SDSF), an Unstructured Data Storage network function (UDSF), and the like.

The UPF 902 may act as an anchor point for intra-RAT and inter-RAT mobility, an external PDU session point of interconnect to DN 903, and a branching point to support multi-homed PDU session. The UPF 902 may also perform packet routing and forwarding, packet inspection, enforce user plane part of policy rules, lawfully intercept packets (UP collection); traffic usage reporting, perform QoS handling for user plane (e.g., packet filtering, gating, UL/DL rate enforcement), perform Uplink Traffic verification (e.g., SDF to QoS flow mapping), transport level packet marking in the uplink and downlink, and downlink packet buffering and downlink data notification triggering. UPF 902 may include an uplink classifier to support routing traffic flows to a data network. The DN 903 may represent various network operator services, Internet access, or third party services. NY 903 may include, or be similar to application server 830 discussed previously.

The AUSF 922 may store data for authentication of UE 901 and handle authentication related functionality. The AUSF 922 may facilitate a common authentication framework for various access types.

The AMF 921 may be responsible for registration management (e.g., for registering UE 901, etc.), connection management, reachability management, mobility management, and lawful interception of AMF-related events, and access authentication and authorization. AMF 921 may provide transport for SM messages between and SMF 924, and act as a transparent proxy for routing SM messages. AMF 921 may also provide transport for short message service (SMS) messages between UE 901 and an SMS function (SMSF) (not shown by FIG. 9). AMF 921 may act as Security Anchor Function (SEA), which may include interaction with the AUSF 922 and the UE 901, receipt of an intermediate key that was established as a result of the UE 901 authentication process. Where USIM based authentication is used, the AMF 921 may retrieve the security material from the AUSF 922. AMF 921 may also include a Security Context Management (SCM) function, which receives a key from the SEA that it uses to derive access-network specific keys. Furthermore, AMF 921 may be a termination point of RAN CP interface (N2 reference point), a termination point of NAS (N1) signalling, and perform NAS ciphering and integrity protection.

AMF 921 may also support NAS signalling with a UE 901 over an N3 interworking-function (IWF) interface. The N3IWF may be used to provide access to untrusted entities. N33IWF may be a termination point for the N2 and N3 interfaces for control plane and user plane, respectively, and as such, may handle N2 signalling from SMF and AMF for PDU sessions and QoS, encapsulate/de-encapsulate packets for IPSec and N3 tunnelling, mark N3 user-plane packets in the uplink, and enforce QoS corresponding to N3 packet marking taking into account QoS requirements associated to such marking received over N2. N3IWF may also relay uplink and downlink control-plane NAS (N1) signalling between the UE 901 and AMF 921, and relay uplink and downlink user-plane packets between the UE 901 and UPF 902. The N3IWF also provides mechanisms for IPsec tunnel establishment with the UE 901.

The SMF 924 may be responsible for session management (e.g., session establishment, modify and release, including tunnel maintain between UPF and AN node); UE IP address allocation & management (including optional Authorization); Selection and control of UP function; Configures traffic steering at UPF to route traffic to proper destination; termination of interfaces towards Policy control functions; control part of policy enforcement and QoS; lawful intercept (for SM events and interface to LI System); termination of SM parts of NAS messages; downlink Data Notification; initiator of AN specific SM information, sent via AMF over N2 to AN; determine SSC mode of a session. The SMF 924 may include the following roaming functionality: handle local enforcement to apply QoS SLAB (VPLMN); charging data collection and charging interface (VPLMN); lawful intercept (in VPLMN for SM events and interface to LI System); support for interaction with external DN for transport of signalling for PDU session authorization/authentication by external DN.

The NEF 923 may provide means for securely exposing the services and capabilities provided by 3GPP network functions for third party, internal exposure/re-exposure, Application Functions (e.g., AF 928), edge computing or fog computing systems, etc. In such embodiments, the NEF 923 may authenticate, authorize, and/or throttle the AFs. NEF 923 may also translate information exchanged with the AF 928 and information exchanged with internal network functions. For example, the NEF 923 may translate between an AF-Service-Identifier and an internal 5GC information. NEF 923 may also receive information from other network functions (NFs) based on exposed capabilities of other network functions. This information may be stored at the NEF 923 as structured data, or at a data storage NF using a standardized interfaces. The stored information may then be re-exposed by the NEF 923 to other NFs and AFs, and/or used for other purposes such as analytics.

The NRF 925 may support service discovery functions, receive NF Discovery Requests from NF instances, and provide the information of the discovered NF instances to the NF instances. NRF 925 also maintains information of available NF instances and their supported services.

The PCF 926 may provide policy rules to control plane function(s) to enforce them, and may also support unified policy framework to govern network behaviour. The PCF 926 may also implement a front end (FE) to access subscription information relevant for policy decisions in a UDR of UDM 927.

The UDM 927 may handle subscription-related information to support the network entities' handling of communication sessions, and may store subscription data of UE 901. The UDM 927 may include two parts, an application FE and a User Data Repository (UDR). The UDM may include a UDM FE, which is in charge of processing of credentials, location management, subscription management and so on. Several different front ends may serve the same user in different transactions. The UDM-FE accesses subscription information stored in the UDR and performs authentication credential processing; user identification handling; access authorization; registration/mobility management; and subscription management. The UDR may interact with PCF 926. UDM 927 may also support SMS management, wherein an SMS-FE implements the similar application logic as discussed previously.

The AF 928 may provide application influence on traffic routing, access to the Network Capability Exposure (NCE), and interact with the policy framework for policy control. The NCE may be a mechanism that allows the 5GC and AF 928 to provide information to each other via NEF 923, which may be used for edge computing implementations. In such implementations, the network operator and third party services may be hosted close to the UE 901 access point of attachment to achieve an efficient service delivery through the reduced end-to-end latency and load on the transport network. For edge computing implementations, the 5GC may select a UPF 902 close to the UE 901 and execute traffic steering from the UPF 902 to DN 903 via the N6 interface. This may be based on the UE subscription data, UE location, and information provided by the AF 928. In this way, the AF 928 may influence UPF (re)selection and traffic routing. Based on operator deployment, when AF 928 is considered to be a trusted entity, the network operator may permit AF 928 to interact directly with relevant NFs.

As discussed previously, the CN 920 may include an SMSF, which may be responsible for SMS subscription checking and verification, and relaying SM messages to/from the UE 901 to/from other entities, such as an SMS-GMSC/IWMSC/SMS-router. The SMS may also interact with AMF 921 and UDM 927 for notification procedure that the UE 901 is available for SMS transfer (e.g., set a UE not reachable flag, and notifying UDM 927 when UE 901 is available for SMS).

The system 900 may include the following service-based interfaces: Namf: Service-based interface exhibited by AMF; Nsmf: Service-based interface exhibited by SMF; Nnef: Service-based interface exhibited by NEF; Npcf: Service-based interface exhibited by PCF; Nudm: Service-based interface exhibited by UDM; Naf: Service-based interface exhibited by AF; Nnrf: Service-based interface exhibited by NRF; and Nausf: Service-based interface exhibited by AUSF.

The system 900 may include the following reference points: N1: Reference point between the UE and the AMF; N2: Reference point between the (R)AN and the AMF; N3: Reference point between the (R)AN and the UPF; N4: Reference point between the SMF and the UPF; and N6: Reference point between the UPF and a Data Network. There may be many more reference points and/or service-based interfaces between the NF services in the NFs, however, these interfaces and reference points have been omitted for clarity. For example, an N5 reference point may be between the PCF and the AF; an N7 reference point may be between the PCF and the SMF; an N11 reference point between the AMF and SMF; etc. In some embodiments, the CN 920 may include an Nx interface, which is an inter-CN interface between the MME (e.g., MME 821) and the AMF 921 in order to enable interworking between CN 920 and CN 820.

Although not shown by FIG. 9, system 900 may include multiple RAN nodes 911 wherein an Xn interface is defined between two or more RAN nodes 911 (e.g., gNBs and the like) that connecting to 5GC 920, between a RAN node 911 (e.g., gNB) connecting to 5GC 920 and an eNB (e.g., a RAN node 811 of FIG. 8), and/or between two eNBs connecting to 5GC 920.

In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 901 in a connected mode (e.g., CM-CONNECTED) including functionality to manage the UE mobility for connected mode between one or more RAN nodes 911. The mobility support may include context transfer from an old (source) serving RAN node 911 to new (target) serving RAN node 911; and control of user plane tunnels between old (source) serving RAN node 911 to new (target) serving RAN node 911.

A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on an SCTP layer. The SCTP layer may be on top of an IP layer. The SCTP layer provides the guaranteed delivery of application layer messages. In the transport IP layer point-to-point transmission is used to deliver the signaling PDUs. In other implementations, the Xn-U protocol stack and/or the Xn-C protocol stack may be same or similar to the user plane and/or control plane protocol stack(s) shown and described herein.

FIG. 10 illustrates example components of a device 1000 in accordance with some embodiments of the present disclosure. In some embodiments, the device 1000 may include application circuitry 1002, baseband circuitry 1004, Radio Frequency (RF) circuitry 1006, front-end module (FEM) circuitry 1008, one or more antennas 1010, and power management circuitry (PMC) 1012 coupled together at least as shown. The components of the illustrated device 1000 may be included in a UE or a RAN node. In some embodiments, the device 1000 may include less elements (e.g., a RAN node may not utilize application circuitry 1002, and instead include a processor/controller to process IP data received from an EPC). In some embodiments, the device 1000 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1002 may include one or more application processors. For example, the application circuitry 1002 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1000. In some embodiments, processors of application circuitry 1002 may process IP data packets received from an EPC.

The baseband circuitry 1004 may include circuitry such as, but not limited to, one or more single-core or multi-core processors. The baseband circuitry 1004 may include one or more baseband processors or control logic to process baseband signals received from a receive signal path of the RF circuitry 1006 and to generate baseband signals for a transmit signal path of the RF circuitry 1006. Baseband processing circuity 1004 may interface with the application circuitry 1002 for generation and processing of the baseband signals and for controlling operations of the RF circuitry 1006. For example, in some embodiments, the baseband circuitry 1004 may include a third generation (3G) baseband processor 1004A, a fourth generation (4G) baseband processor 1004B, a fifth generation (5G) baseband processor 1004C, or other baseband processor(s) 1004D for other existing generations, generations in development or to be developed in the future (e.g., second generation (2G), sixth generation (6G), etc.). The baseband circuitry 1004 (e.g., one or more of baseband processors 1004A-D) may handle various radio control functions that enable communication with one or more radio networks via the RF circuitry 1006. In other embodiments, some or all of the functionality of baseband processors 1004A-D may be included in modules stored in the memory 1004G and executed via a Central Processing Unit (CPU) 1004E. The radio control functions may include, but are not limited to, signal modulation/demodulation, encoding/decoding, radio frequency shifting, etc. In some embodiments, modulation/demodulation circuitry of the baseband circuitry 1004 may include Fast-Fourier Transform (FFT), precoding, or constellation mapping/demapping functionality. In some embodiments, encoding/decoding circuitry of the baseband circuitry 1004 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1004 may include one or more audio digital signal processor(s) (DSP) 1004F. The audio DSP(s) 1004F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1004 and the application circuitry 1002 may be implemented together such as, for example, on a system on a chip (SOC).

In some embodiments, the baseband circuitry 1004 may provide for communication compatible with one or more radio technologies. For example, in some embodiments, the baseband circuitry 1004 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 1004 is configured to support radio communications of more than one wireless protocol may be referred to as multi-mode baseband circuitry.

RF circuitry 1006 may enable communication with wireless networks using modulated electromagnetic radiation through a non-solid medium. In various embodiments, the RF circuitry 1006 may include switches, filters, amplifiers, etc. to facilitate the communication with the wireless network. RF circuitry 1006 may include a receive signal path which may include circuitry to down-convert RF signals received from the FEM circuitry 1008 and provide baseband signals to the baseband circuitry 1004. RF circuitry 1006 may also include a transmit signal path which may include circuitry to up-convert baseband signals provided by the baseband circuitry 1004 and provide RF output signals to the FEM circuitry 1008 for transmission.

In some embodiments, the receive signal path of the RF circuitry 1006 may include mixer circuitry 1006a, amplifier circuitry 1006b and filter circuitry 1006c. In some embodiments, the transmit signal path of the RF circuitry 1006 may include filter circuitry 1006c and mixer circuitry 1006a. RF circuitry 1006 may also include synthesizer circuitry 1006d for synthesizing a frequency for use by the mixer circuitry 1006a of the receive signal path and the transmit signal path. In some embodiments, the mixer circuitry 1006a of the receive signal path may be configured to down-convert RF signals received from the FEM circuitry 1008 based on the synthesized frequency provided by synthesizer circuitry 1006d. The amplifier circuitry 1006b may be configured to amplify the down-converted signals and the filter circuitry 1006c may be a low-pass filter (LPF) or band-pass filter (BPF) configured to remove unwanted signals from the down-converted signals to generate output baseband signals. Output baseband signals may be provided to the baseband circuitry 1004 for further processing. In some embodiments, the output baseband signals may be zero-frequency baseband signals, although this is not a requirement. In some embodiments, mixer circuitry 1006a of the receive signal path may comprise passive mixers, although the scope of the embodiments is not limited in this respect.

In some embodiments, the mixer circuitry 1006a of the transmit signal path may be configured to up-convert input baseband signals based on the synthesized frequency provided by the synthesizer circuitry 1006d to generate RF output signals for the FEM circuitry 1008. The baseband signals may be provided by the baseband circuitry 1004 and may be filtered by filter circuitry 1006c.

In some embodiments, the mixer circuitry 1006a of the receive signal path and the mixer circuitry 1006a of the transmit signal path may include two or more mixers and may be arranged for quadrature downconversion and upconversion, respectively. In some embodiments, the mixer circuitry 1006a of the receive signal path and the mixer circuitry 1006a of the transmit signal path may include two or more mixers and may be arranged for image rejection (e.g., Hartley image rejection). In some embodiments, the mixer circuitry 1006a of the receive signal path and the mixer circuitry 1006a may be arranged for direct downconversion and direct upconversion, respectively. In some embodiments, the mixer circuitry 1006a of the receive signal path and the mixer circuitry 1006a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1006 may include analog-to-digital converter (ADC) and digital-to-analog converter (DAC) circuitry and the baseband circuitry 1004 may include a digital baseband interface to communicate with the RF circuitry 1006.

In some dual-mode embodiments, a separate radio IC circuitry may be provided for processing signals for each spectrum, although the scope of the embodiments is not limited in this respect.

In some embodiments, the synthesizer circuitry 1006d may be a fractional-N synthesizer or a fractional N/N+1 synthesizer, although the scope of the embodiments is not limited in this respect as other types of frequency synthesizers may be suitable. For example, synthesizer circuitry 1006d may be a delta-sigma synthesizer, a frequency multiplier, or a synthesizer comprising a phase-locked loop with a frequency divider.

The synthesizer circuitry 1006d may be configured to synthesize an output frequency for use by the mixer circuitry 1006a of the RF circuitry 1006 based on a frequency input and a divider control input. In some embodiments, the synthesizer circuitry 1006d may be a fractional N/N+1 synthesizer.

In some embodiments, frequency input may be provided by a voltage controlled oscillator (VCO), although that is not a requirement. Divider control input may be provided by either the baseband circuitry 1004 or the applications processor 1002 depending on the desired output frequency. In some embodiments, a divider control input (e.g., N) may be determined from a look-up table based on a channel indicated by the applications processor 1002.

Synthesizer circuitry 1006d of the RF circuitry 1006 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1006d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1006 may include an IQ/polar converter.

FEM circuitry 1008 may include a receive signal path which may include circuitry configured to operate on RF signals received from one or more antennas 1010, amplify the received signals and provide the amplified versions of the received signals to the RF circuitry 1006 for further processing. FEM circuitry 1008 may also include a transmit signal path which may include circuitry configured to amplify signals for transmission provided by the RF circuitry 1006 for transmission by one or more of the one or more antennas 1010. In various embodiments, the amplification through the transmit or receive signal paths may be done solely in the RF circuitry 1006, solely in the FEM 1008, or in both the RF circuitry 1006 and the FEM 1008.

In some embodiments, the FEM circuitry 1008 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 1006). The transmit signal path of the FEM circuitry 1008 may include a power amplifier (PA) to amplify input RF signals (e.g., provided by RF circuitry 1006), and one or more filters to generate RF signals for subsequent transmission (e.g., by one or more of the one or more antennas 1010).

In some embodiments, the PMC 1012 may manage power provided to the baseband circuitry 1004. In particular, the PMC 1012 may control power-source selection, voltage scaling, battery charging, or DC-to-DC conversion. The PMC 1012 may often be included when the device 1000 is capable of being powered by a battery, for example, when the device is included in a UE. The PMC 1012 may increase the power conversion efficiency while providing desirable implementation size and heat dissipation characteristics.

While FIG. 10 shows the PMC 1012 coupled only with the baseband circuitry 1004. However, in other embodiments, the PMC 10 12 may be additionally or alternatively coupled with, and perform similar power management operations for, other components such as, but not limited to, application circuitry 1002, RF circuitry 1006, or FEM 1008.

In some embodiments, the PMC 1012 may control, or otherwise be part of, various power saving mechanisms of the device 1000. For example, if the device 1000 is in an RRC_Connected state, where it is still connected to the RAN node as it expects to receive traffic shortly, then it may enter a state known as Discontinuous Reception Mode (DRX) after a period of inactivity. During this state, the device 1000 may power down for brief intervals of time and thus save power.

If there is no data traffic activity for an e10ended period of time, then the device 1000 may transition off to an RRC_Idle state, where it disconnects from the network and does not perform operations such as channel quality feedback, handover, etc. The device 1000 goes into a very low power state and it performs paging where again it periodically wakes up to listen to the network and then powers down again. The device 1000 may not receive data in this state, in order to receive data, it may transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1002 and processors of the baseband circuitry 1004 may be used to execute elements of one or more instances of a protocol stack. For example, processors of the baseband circuitry 1004, alone or in combination, may be used execute Layer 3, Layer 2, or Layer 1 functionality, while processors of the application circuitry 1004 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 11 illustrates example interfaces of baseband circuitry in accordance with some embodiments of the present disclosure. As discussed above, the baseband circuitry 1004 of FIG. 10 may comprise processors 1004A-1004E and a memory 1004G utilized by said processors. Each of the processors 1004A-1004E may include a memory interface, 1104A-1104E, respectively, to send/receive data to/from the memory 1004G.

The baseband circuitry 1004 may further include one or more interfaces to communicatively couple to other circuitries/devices, such as a memory interface 1112 (e.g., an interface to send/receive data to/from memory external to the baseband circuitry 1004), an application circuitry interface 1114 (e.g., an interface to send/receive data to/from the application circuitry 1002 of FIG. 10), an RF circuitry interface 1116 (e.g., an interface to send/receive data to/from RF circuitry 1006 of FIG. 10), a wireless hardware connectivity interface 1118 (e.g., an interface to send/receive data to/from Near Field Communication (NFC) components, Bluetooth® components (e.g., Bluetooth® Low Energy), Wi-Fi® components, and other communication components), and a power management interface 1120 (e.g., an interface to send/receive power or control signals to/from the PMC 1012.

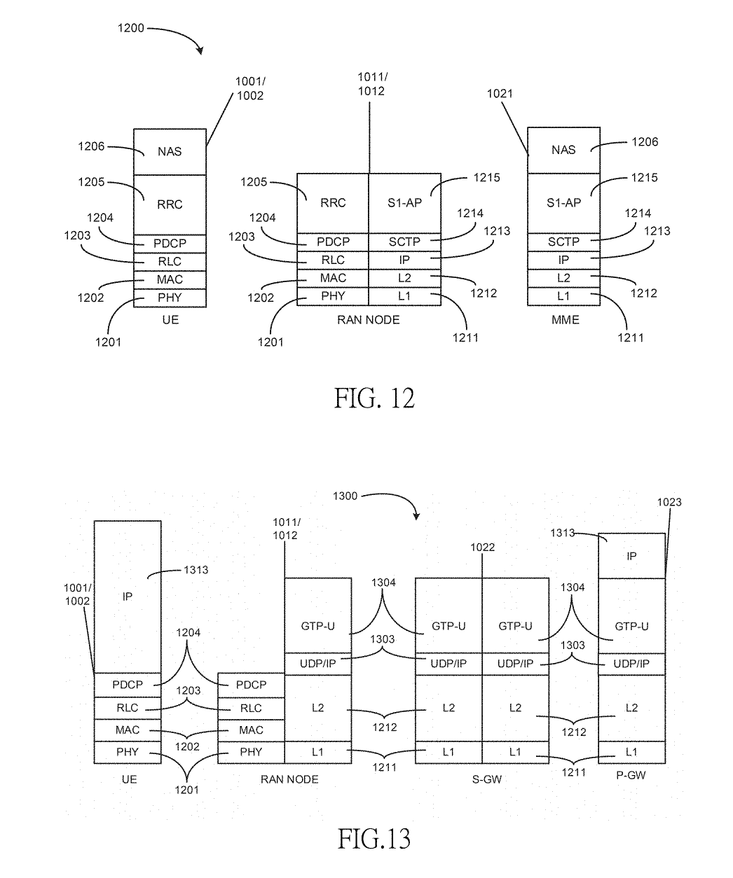

FIG. 12 is an illustration of a control plane protocol stack in accordance with some embodiments of the present disclosure. In this embodiment, a control plane 1200 is shown as a communications protocol stack between the UE 801 (or alternatively, the UE 802), the RAN node 811 (or alternatively, the RAN node 812), and the MME 821.

The PHY layer 1201 may transmit or receive information used by the MAC layer 1202 over one or more air interfaces. The PHY layer 1201 may further perform link adaptation or adaptive modulation and coding (AMC), power control, cell search (e.g., for initial synchronization and handover purposes), and other measurements used by higher layers, such as the RRC layer 1205. The PHY layer 1201 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 1202 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARD), and logical channel prioritization.

The RLC layer 1203 may operate in a plurality of modes of operation, including: Transparent Mode (TM), Unacknowledged Mode (UM), and Acknowledged Mode (AM). The RLC layer 1203 may execute transfer of upper layer protocol data units (PDUs), error correction through automatic repeat request (ARQ) for AM data transfers, and concatenation, segmentation and reassembly of RLC SDUs for UM and AM data transfers. The RLC layer 1203 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 1204 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 1205 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 801 and the RAN node 811 may utilize a Uu interface (e.g., an LTE-Uu interface) to exchange control plane data via a protocol stack comprising the PHY layer 1201, the MAC layer 1202, the RLC layer 1203, the PDCP layer 1204, and the RRC layer 1205.

The non-access stratum (NAS) protocols 1206 form the highest stratum of the control plane between the UE 801 and the MME 821. The NAS protocols 1206 support the mobility of the UE 801 and the session management procedures to establish and maintain IP connectivity between the UE 801 and the P-GW 823.

The S1 Application Protocol (S1-AP) layer 1215 may support the functions of the S1 interface and comprise Elementary Procedures (EPs). An EP is a unit of interaction between the RAN node 811 and the CN 820. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 1214 may ensure reliable delivery of signaling messages between the RAN node 811 and the MME 821 based, in part, on the IP protocol, supported by the IP layer 1213. The L2 layer 1212 and the L1 layer 1211 may refer to communication links (e.g., wired or wireless) used by the RAN node and the MME to exchange information.

The RAN node 811 and the MME 821 may utilize an S1-MME interface to exchange control plane data via a protocol stack comprising the L1 layer 1211, the L2 layer 1212, the IP layer 1213, the SCTP layer 1214, and the S1-AP layer 1215.

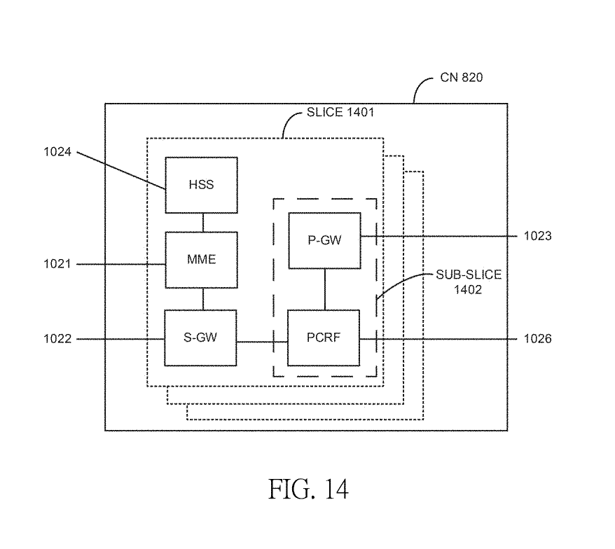

FIG. 13 is an illustration of a user plane protocol stack in accordance with some embodiments of the present disclosure. In this embodiment, a user plane 1300 is shown as a communications protocol stack between the UE 801 (or alternatively, the UE 802), the RAN node 811 (or alternatively, the RAN node 812), the S-GW 822, and the P-GW 823. The user plane 1300 may utilize at least some of the same protocol layers as the control plane 1200. For example, the UE 801 and the RAN node 811 may utilize a Uu interface (e.g., an LTE-Uu interface) to exchange user plane data via a protocol stack comprising the PHY layer 1201, the MAC layer 1202, the RLC layer 1203, the PDCP layer 1204.

The General Packet Radio Service (GPRS) Tunneling Protocol for the user plane (GTP-U) layer 1304 may be used for carrying user data within the GPRS core network and between the radio access network and the core network. The user data transported may be packets in any of IPv4, IPv6, or PPP formats, for example. The UDP and IP security (UDP/IP) layer 1303 may provide checksums for data integrity, port numbers for addressing different functions at the source and destination, and encryption and authentication on the selected data flows. The RAN node 811 and the S-GW 822 may utilize an S1-U interface to exchange user plane data via a protocol stack comprising the L1 layer 1211, the L2 layer 1212, the UDP/IP layer 1303, and the GTP-U layer 1304. The S-GW 822 and the P-GW 823 may utilize an S5/S8a interface to exchange user plane data via a protocol stack comprising the L1 layer 1211, the L2 layer 1212, the UDP/IP layer 1303, and the GTP-U layer 1304. As discussed above with respect to FIG. 12, NAS protocols support the mobility of the UE 801 and the session management procedures to establish and maintain IP connectivity between the UE 801 and the P-GW 823.

FIG. 14 illustrates components of a core network in accordance with some embodiments of the present disclosure. The components of the CN 820 may be implemented in one physical node or separate physical nodes including components to read and execute instructions from a machine-readable or computer-readable medium (e.g., a non-transitory machine-readable storage medium). In embodiments, the components of CN 920 may be implemented in a same or similar manner as discussed herein with regard to the components of CN 820. In some embodiments, Network Functions Virtualization (NFV) is utilized to virtualize any or all of the above described network node functions via executable instructions stored in one or more computer readable storage mediums (described in further detail below). A logical instantiation of the CN 820 may be referred to as a network slice 1401. A logical instantiation of a portion of the CN 820 may be referred to as a network sub-slice 1402 (e.g., the network sub-slice 1402 is shown to include the PGW 823 and the PCRF 826).

NFV architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

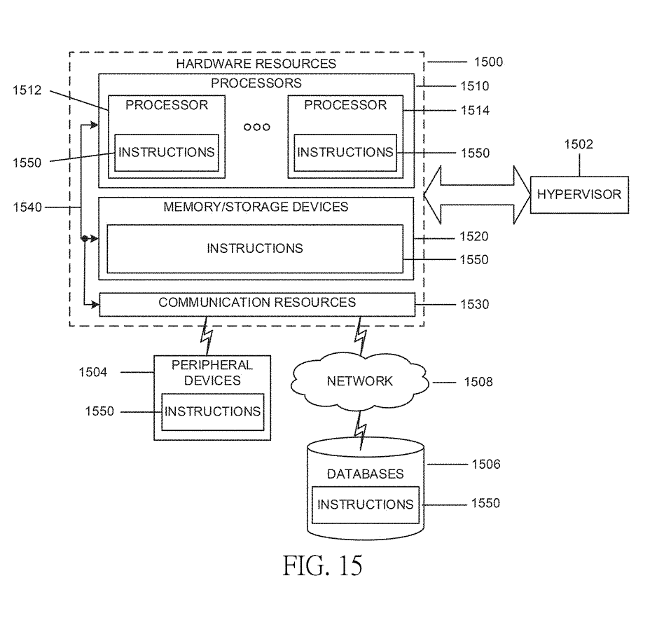

FIG. 15 is a block diagram illustrating components, according to some example embodiments of the present disclosure, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540. For embodiments where node virtualization (e.g., NFV) is utilized, a hypervisor 1502 may be executed to provide an execution environment for one or more network slices/sub-slices to utilize the hardware resources 1500

The processors 1510 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1512 and a processor 1514.

The memory/storage devices 1520 may include main memory, disk storage, or any suitable combination thereof. The memory/storage devices 1520 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1530 may include interconnection or network interface components or other suitable devices to communicate with one or more peripheral devices 1504 or one or more databases 1506 via a network 1508. For example, the communication resources 1530 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable medium.

In some embodiments, the electronic device(s), network(s), system(s), chip(s) or component(s), or portions or implementations thereof, of any figure herein may be configured to perform one or more processes, techniques, or methods as described herein, or portions thereof.

### EXAMPLES

Example 1 may include an apparatus configured to be employed in an evolved nodeB (eNB), comprising: a memory interface; and processing circuitry, configured to: identify configuration of a channel whitelist and configuration of a frame structure parameter; utilize each bit of a bitmap corresponding to a specific channel associated with the configuration of the channel whitelist and the configuration of the frame structure parameter to determine whether the channel has been chosen or not; utilize a combination index for the channel whitelist when considering all permutations of available channels N_{cH} in group of Nd channel; generate channel whitelist indication data based on the bitmap; and send the channel whitelist indication data to a memory via the memory interface; wherein the channel whitelist is contained in SIB-BR (system information block-bandwidth reduced), reduced SIB-BR, or MIB (master information block); N_{CH} is total channel number, N_{d} is the number of data channel for hopping.

Example 2 may include the subject matter of Example 1, wherein the processing circuitry is configured to utilize 56 bitmap, excluding 3 anchor channels in 83.5 MHz.

Example 3 may include the subject matter of Examples 1-2, the combination index is represented by ┌log 2(C_{N}_{_{CD}}^{N}^{_{d}})┘, representing ┌log 2(C_{N}_{_{CH}}^{N}^{_{d}})┘ bits are required for the channel whitelist, wherein C is an operator permutation.

Example 4 may include the subject matter of Examples 1-3, the bitmap is configured such that “1” is used to indicate a channel has been chosen, and “0” is used to indicate a channel will not be chosen.

Example 5 may include the subject matter of Examples 1-4, wherein maximum of the combination index is 53.

Example 6 may include the subject matter of Examples 1-5, wherein size for the combination index of the channel whitelist is reduced by grouping Ngroup channels, one of the channels within a group is chosen for transmission, ┌log 2(C_{┌N}_{_{CH}}_{/N}_{_{group}}_{┘}^{N}^{_{d}})┘ bits are used to select one of the groups, ┌log 2(N_{group})┘ bits are used to select a specific channel.

Example 7 may include the subject matter of Examples 1-6, wherein Ngroup is 2.

Example 8 may include the subject matter of Examples 1-7, the size for the combination index of the channel whitelist is reduced by grouping Ngroup channels, n_{d} channels is selected within a group are chose for transmission, ┌log 2(N_{group}ⁿ^{_{d}})┘ is desired for multiple channel selection within a group; wherein n_{d} is the number of multiple data channel channels selected within a group.

Example 9 may include the subject matter of Examples 6 or 8, when Ngroup is 2.

Example 10 may include the subject matter of Examples 1-9, wherein when a group is chosen, all the channels within the group are also chosen, and if the number of data channel exceed the required channel Nd number for hopping, only a part of those channels will be used, wherein either the large or small channel indexes of the combination index of the channel whitelist in the first or last group are dropped.

Example 11 may include the subject matter of Examples 1-10, wherein size for the combination index of the channel whitelist is reduced by forming Ngroup group of channels, ┌log 2(N_{group})┘ bits are used to select the sequence of a specific group, ┌log 2(C_{N}_{_{d}}^{┌N}^{_{CD}}^{/N}^{_{group}}^{┘})┘ bits are used to identify the specific sequence within the group.

Example 12 may include the subject matter of Examples 1-11, ┌log 2(N_{group})┘ is 27.

Example 13 may include the subject matter of Examples 1-12, wherein the contiguous or equidistant channel groups are selected.

Example 14 may include the subject matter of Examples 1-13, the contiguous channel groups are selected, wherein Ngroup=2, Nd=15, and one channel is selected within each group.

Example 15 may include the subject matter of Examples 1-13, the equidistant channel groups are selected, and the groups are composed by channels which have a particular structure and two adjacent channels are not distant from each other more than 1 channel.

Example 16 may include the subject matter of Examples 1-15, wherein the channel groups and the channel selection within a group are indicated by one indicator, to further reduce the overhead by reducing the unused bits.

Example 17 may include the subject matter of Examples 1-16, whether the processing circuitry is configured to: determine a localized or distributed channel selection, which are indicated through high layer signaling.

Example 18 may include the subject matter of Examples 1-17, wherein the high layer signaling is MIB/SIB.

Example 19 may include the subject matter of Examples 1-18, wherein the dwell time of anchor channel is changed as following: T_{DRS}=5/8/10/15/20 ms; the period of DRS is 40/80/160/320 ms.

Example 20 may include the subject matter of Examples 1-19, the processing circuitry is configured to satisfy at least one of the following conditions: T_{DRS}+N_{d,Return}*T_{d}=40/80/160/320 and N_{d}T_{DRS}=N_{d,Return}*T_{d}; wherein T_{DRS} is the anchor channel dwell time; N_{d,Reture} is the number of data channels between the gap of two adjacent DRS; T^{d} is the dwell time of data channels; N_{d} is the number of data channels.

Example 21 may include the subject matter of Example 20, when T_{DRs}=5 ms, the Period of DRS, the N_{d,Reture}, the T_{d} and N_{d} are represented from the following:

| Period | | |
|---|---|---|
| of DRS | N_{d, Return} * T_{d} | N_{d} |
| 40 ms | 35 ms | none |
| 80 ms | 75 ms | 15 |
| | N_{d, Return} = 1, T_{d} = 75 ms | |
| 160 ms | 155 ms | 31 |
| | N_{d, Return} = 1, T_{d} = 155 ms | |
| 320 ms | 315 ms | 63 |
| | N_{d, Return} = 3, T_{d} = 105 ms or | |
| | N_{d, Return} = 5, T_{d} = 63 ms | |

Example 22 may include the subject matter of Example 20, when T_{DRS}=8 ms, the Period of DRS, the N_{d,Reture}, the T_{d} and N_{d} are represented from the following:

| Period | | |
|---|---|---|
| of DRS | N_{d, Return} * T_{d} | N_{d} |
| 40 ms | 32 ms | none |
| 80 ms | 72 ms | none |
| | N_{d, Return} = 1, T_{d} = 72 ms | |
| 160 ms | 152 ms | 19 |
| | N_{d, Return} = 1, T_{d} = 152 ms | |
| | N_{d, Return} = 2, T_{d} = 76 ms | |
| 320 ms | 312 ms | 39 |
| | N_{d, Return} = 1, T_{d} = 312 ms | |
| | or | |
| | N_{d, Return} = 2, T_{d} = 156 ms | |
| | or | |
| | N_{d, Return} = 3, T_{d} = 104 ms | |

Example 23 may include the subject matter of Example 20, when T_{DRS}=10 ms, the Period of DRS, the N_{d,Reture}, the T_{d} and N_{d} are represented from the following:

| Period | | |
|---|---|---|
| of DRS | N_{d, Return} * T_{d} | N_{d} |
| 40 ms | 30 ms | none |
| 80 ms | 70 ms | none |
| | N_{d, Return} = 1, T_{d} = 70 ms | |
| 160 ms | 150 ms | 15 |
| | N_{d, Return} = 1, T_{d} = 150 ms | |
| | N_{d, Return} = 2, T_{d} = 75 ms | |
| | N_{d, Return} = 3, T_{d} = 50 ms | |
| 320 ms | 310 ms | 31 |
| | N_{d, Return} = 1, T_{d} = 310 ms | |
| | N_{d, Return} = 2, T_{d} = 155 ms | |
| | N_{d, Return} = 5, T_{d} = 62 ms | |

Example 24 may include the subject matter of Example 20, when T_{DRS}=15 ms, the Period of DRS, the N_{d,Reture}, and the T_{d} are represented from the following:

| Period | |
|---|---|
| of DRS | N_{d, Return} * T_{d} |
| 40 ms | 25 ms |
| | N_{d, Return} = 1, T_{d} = 25 ms |
| 80 ms | 65 ms |
| | N_{d, Return} = 1, T_{d} = 65 ms |
| 160 ms | 145 ms |
| | N_{d, Return} = 1, T_{d} = 145 ms |
| | or |
| | N_{d, Return} = 5, T_{d} = 29 ms |
| 320 ms | 305 ms |
| | N_{d, Return} = 1, T_{d} = 305 ms |
| | or |
| | N_{d, Return} = 5, T_{d} = 61 ms |

Example 25 may include the subject matter of Example 20, when T_{DRS}=20 ms, the Period of DRS, the N_{d,Reture}, and the T_{d} are represented from the following:

| Period | |
|---|---|
| of DRS | N_{d, Return} * T_{d} |
| 40 ms | 20 ms |
| | N_{d, Return} = 1, T_{d} = 20 ms |
| 80 ms | 60 ms |
| | N_{d, Return} = 1, T_{d} = 60 ms |
| | N_{d, Return} = 2, T_{d} = 30 ms |
| 160 ms | 140 ms |
| | N_{d, Return} = 1, T_{d} = 140 ms |
| | or |
| | N_{d, Return} = 2, T_{d} = 70 ms |
| 320 ms | 300 ms |
| | N_{d, Return} = 1, T_{d} = 300 ms |
| | N_{d, Return} = 2, T_{d} = 150 ms |
| | or |
| | N_{d, Return} = 3, T_{d} = 100 ms |
| | or |
| | N_{d, Return} = 4, T_{d} = 75 ms |
| | or |
| | N_{d, Return} = 5, T_{d} = 60 ms |

Example 26 may include the subject matter of Examples 1 or 20, the processing circuitry is configured to: choose and pre-define one or multiple of the parameter combinations; and utilize an index to indicate (T_{DRS}, N_{d,Reture}, T_{d}, N_{d}, P_{DRS}) in the MIB or SIB; wherein P_{DRS} is the period of DRS.

Example 27 may include the subject matter of Examples 1-26, the processing circuitry is configured to: determine N_{d} independently; and pre-define a number group.

Example 28 may include the subject matter of Example 27, wherein N_{d} is 15.

Example 29 may include the subject matter of Example 27, wherein the minimum number of group including 15.

Example 30 may include the subject matter of Example 27, wherein the multiples of the minimum channel including {15, 30, 45, 60}.

Example 31 may include the subject matter of Example 27, wherein the maximum number of channel is 56.

Example 32 may include the subject matter of Example 27, wherein the primes number is adopted for easy random sequence generation, such as {17, 19, 23, 29, 31, 37, 41, 43, 47}.

Example 33 may include the subject matter of Example 27, wherein the primes number is adopted for easy random sequence generation, such as {17, 19, 23, 29, 31, 37, 41, 43, 47}.

Example 34 may include a computer-readable medium comprising instructions that, when executed, cause an electronic device to: identify configuration of a channel whitelist and configuration of a frame structure parameter; utilize each bit of a bitmap corresponding to a specific channel associated with the configuration of the channel whitelist and the configuration of the frame structure parameter to determine whether the channel has been chosen or not; utilize a combination index for the channel whitelist when considering all permutations of available channels N_{CH} in group of Nd channel; generate channel whitelist indication data based on the bitmap; and send the channel whitelist indication data to a memory via the memory interface; wherein the channel whitelist is contained in SIB-BR (system information block-bandwidth reduced), reduced SIB-BR, or MIB (master information block); N_{CH} is total channel number, N_{d} is the number of data channel for hopping.

Example 35 may include a computer-readable medium comprising instructions that, when executed, cause an electronic device to: identify configuration of a channel whitelist; utilize each bit of a bitmap corresponding to a specific channel associated with the configuration of the channel whitelist to determine whether the channel has been chosen or not; utilize a combination index for the channel whitelist when considering all permutations of available channels N_{CH} in group of Nd channel; generate channel whitelist indication data based on the bitmap; and send the channel whitelist indication data to a memory via the memory interface; wherein the channel whitelist is contained in SIB-BR (system information block-bandwidth reduced), reduced SIB-BR, or MIB (master information block); N_{CH} is total channel number, N_{d} is the number of data channel for hopping.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

1. An apparatus configured to be employed in an evolved nodeB (eNB), comprising:
a memory interface; and
processing circuitry, configured to:
identify configuration of a channel whitelist and configuration of a frame structure parameter;
utilize each bit of a bitmap corresponding to a specific channel associated with the configuration of the channel whitelist and the configuration of the frame structure parameter to determine whether the channel has been chosen or not;
utilize a combination index for the channel whitelist when considering all permutations of available channels N_{CH} in group of Nd channels;
generate channel whitelist indication data based on the bitmap; and
send the channel whitelist indication data to a memory via the memory interface;
wherein
the channel whitelist is contained in SIB-BR (system information block-bandwidth reduced), reduced SIB-BR, or MIB (master information block);
N_{CH} is total channel number, N_{d} is the number of data channel for hopping.

2. The apparatus according to claim 1, wherein the processing circuitry is configured to utilize 56 bitmap, excluding 3 anchor channels in 83.5 MHz.

3. The apparatus according to claim 1, wherein
the combination index is represented by ┌log 2(C_{N}_{_{CH}}^{N}^{_{d}})┘, representing ┌log 2(C_{N}_{_{CD}}^{N}^{_{d}})┘ bits that are required for the channel whitelist, wherein C is an operator permutation.

4. The apparatus according to claim 1, wherein the bitmap is configured such that “1” is used to indicate a channel has been chosen, and “0” is used to indicate a channel will not be chosen.

5. The apparatus according to claim 1, wherein size for the combination index of the channel whitelist is reduced by grouping N_{group} channels, one of the channels within a group is chosen for transmission, ┌log 2(C_{┌N}_{_{CH}}_{/N}_{_{group}}_{┘}^{N}^{_{d}})┘ bits are used to select one of the groups, ┌log 2(N_{group})┘ bits are used to select a specific channel.

6. The apparatus according to claim 5, wherein N_{group} is 2.

7. The apparatus according to claim 5, wherein
contiguous or equidistant channel groups are selected.

8. The apparatus according to claim 7, the equidistant channel groups are selected, and the groups are composed by channels which have a particular structure and two adjacent channels are not distant from each other more than 1 channel.

9. The apparatus according to claim 5, wherein when a group is chosen, all the channels within the group are also chosen, and if the number of data channel exceed the required channel N_{d} number for hopping, only a part of those channels will be used,
wherein either large or small channel indexes of the combination index of the channel whitelist in the first or last group are dropped.

10. The apparatus according to claim 1, wherein the size for the combination index of the channel whitelist is reduced by grouping N_{group} channels, n_{d} channels of the channels within a group are chosen for transmission, and ┌log 2(C_{N}_{_{group}}ⁿ^{_{d}})┘ bits are used for multiple channel selection within a group; wherein
n_{d} is the number of multiple data channel channels selected within a group.

11. The apparatus according to claim 1, wherein the size for the combination index of the channel whitelist is reduced by forming N_{group} group of channels, ┌log 2(N_{group})┘ bits are used to select the sequence of a specific group, and ┌log 2 (C_{N}_{_{d}}^{┌N}^{_{CH}}^{/N}^{_{group}}^{┘})┘ bits are used to identify the specific sequence within the group.

12. The apparatus according to claim 1, wherein the channel groups and the channel selection within a group are indicated by one indicator.

13. The apparatus according to claim 1, whether the processing circuitry is configured to: determine a localized or distributed channel selection, which are indicated through high layer signaling.

14. The apparatus according to claim 1, wherein
the processing circuitry is configured to satisfy at least one of the following conditions: T_{DRS}+N_{d,Return}*T_{d}=40/80/160/320 ms and N_{d}T_{DRS}=N_{d,Return}*T_{d} ms; wherein
T_{DRS} is the anchor channel dwell time;
N_{d,Reture} is the number of data channels between the gap of two adjacent DRS;
T_{d} is the dwell time of data channels;
N_{d} is the number of data channels.

15. The apparatus according to claim 1, the processing circuitry is configured to:
choose and pre-define one or multiple of the parameter combinations; and
utilize an index to indicate (T_{DRS}, N_{d,Reture}, T_{d} N_{d} P_{DRS}) in the MIB or SIB;
wherein P_{DRS} is the period of DRS.

16. The apparatus according to claim 1, the processing circuitry is configured to:
determine N_{d} independently; and
pre-define a number group.

17. The apparatus according to claim 1, wherein the processing circuitry is configured to:
determine an arbitrary channel number.

18. One or more non-transitory, computer-readable media comprising instructions that, when executed, cause an electronic device to:
identify configuration of a channel whitelist and configuration of a frame structure parameter;
utilize each bit of a bitmap corresponding to a specific channel associated with the configuration of the channel whitelist and the configuration of the frame structure parameter to determine whether the channel has been chosen or not;
utilize a combination index for the channel whitelist when considering all permutations of available channels N_{CH} in group of Nd channel;
generate channel whitelist indication data based on the bitmap; and
send the channel whitelist indication data to a memory; wherein
the channel whitelist is contained in SIB-BR (system information block-bandwidth reduced), reduced SIB-BR, or MIB (master information block);
N_{CH} is total channel number, N_{d} is the number of data channel for hopping.

19. The one or more non-transitory, computer-readable media according to claim 18, the size for the combination index of the channel whitelist is reduced by grouping N_{group} channels, n_{d} channels of the channels within a group are chosen for transmission, ┌log 2(C_{N}_{_{group}}ⁿ^{_{d}})┘ bits are used for multiple channel selection within a group; wherein
n_{d} is the number of multiple data channels selected within a group.

20. One or more non-transitory, computer-readable media comprising instructions that, when executed, cause an electronic device to:
identify configuration of a channel whitelist;
utilize each bit of a bitmap corresponding to a specific channel associated with the configuration of the channel whitelist to determine whether the channel has been chosen or not;
utilize a combination index for the channel whitelist when considering all permutations of available channels N_{CH} in group of Nd channel;
generate channel whitelist indication data based on the bitmap; and
send the channel whitelist indication data to a memory; wherein
the channel whitelist is contained in SIB-BR (system information block-bandwidth reduced), reduced SIB-BR, or MIB (master information block);
N_{CH} is total channel number, N_{d} is the number of data channel for hopping.
